(19) United States
(12) Patent Application Publication
(10) Pub. No.: US 2026/0089261 A1
(43) Pub. Date: Mar. 26, 2026

(54) GENERATIVE ARTIFICIAL INTELLIGENCE-DRIVEN SYSTEM FOR REAL-TIME CALL QUEUE MANAGEMENT

(71) Applicant: Bank of America Corporation, Charlotte, NC (US)

(72) Inventors: Nipun Mahajan, Lawrenceville, NJ (US); Amit Mishra, Chennai (IN); Balaji Sugumar, Chennai (IN); Shubhakar A, Chennai (IN); S.B. Pravin Kumar, Nagercoil (IN); Yogesh Raghuvanshi, Pennington, NJ (US); Sushil Golani, Waxhaw, NC (US)

(21) Appl. No.: 18/898,070

(22) Filed: Sep. 26, 2024

(51) Int. Cl. H04M 3/523; G10L 13/00; G10L 15/18; G10L 15/26

(52) U.S. Cl. CPC H04M 3/5232; G10L 13/00; G10L 15/1815; G10L 15/26

(57) ABSTRACT

A system for reducing call wait times by dynamically managing communication channels includes a memory and a processor. The memory stores user profile data, prioritization rules, channel selection criteria, and operational instructions. The processor analyzes a first audio signal from an incoming call to identify the call's intent using a large language model. The system determines the call's priority level based on the identified intent, the user's identity, and the prioritization rules, which map the set of intents, user identities, and call priorities. Based on the determined priority level and channel selection criteria, the processor identifies the optimal communication channel, such as a virtual audio channel. The processor receives a second audio signal, converts it to text transcript, processes the text with a virtual assistant large language model to generate a response, converts the text response to audio using text-to-voice instructions, and transmits the audio output back to the user.

### TECHNICAL FIELD

The present disclosure relates generally to use of generative artificial intelligence for assistance with calls, and more specifically to generative artificial intelligence-driven system for real-time call queue management.

### BACKGROUND

Artificial Intelligence (AI) has been widely adopted across various technical fields, including engineering, communications, finance, and customer service. In particular, AI has significantly transformed call center operations by optimizing processes such as call routing, customer query resolution, and agent support. AI technologies, including natural language processing and machine learning, have enabled call centers to provide enhanced customer experiences through chatbots, automated responses, and personalized service.

Despite these advancements, a notable challenge remains in environments where customers are unable to utilize chat or other digital communication channels such as SMS or email. In many scenarios, especially where customers have limited access to these technologies or prefer using a traditional phone call, the interaction is restricted to audio-only communication. This limitation can reduce the efficiency and effectiveness of customer service interactions, as it prevents the utilization of AI-driven features that are available in digital channels.

### SUMMARY

The disclosed system and method are specifically integrated into a practical application for reducing call wait times in contact centers by leveraging advanced machine learning models to optimize the selection of communication channels and facilitate interactions through these channels. The system employs novel algorithms based on artificial intelligence (AI) to interact with clients via phone, utilizing machine learning models (MLMs) to identify call intent, contextual information within call data, as well as emotional state of the user during the call, and dynamically adjust communication strategies in real-time.

The present disclosure describes a system and method for efficiently managing call center interactions by leveraging AI to process audio signals, detect customer needs, and select the most appropriate communication channel, thereby enhancing customer experience and optimizing resource use.

The disclosed system enhances the efficiency of processing, memory, and network resources by mitigating the call demands associated with customer service representatives. By automating the detection of call intents, contextual information within call data, and emotional state of the user during the call using a combination of large language models (LLMs) and emotional intelligence (EI) MLMs, the system reduces the load on agents and improves the overall management of call queues.

The disclosed system and method are designed to dynamically adjust the communication channel based on real-time analysis of customer interactions, which ensures that calls are handled in the most efficient manner. For example, the system can detect a high-priority call based on the intent and identity of the user, and seamlessly transition the interaction to an agent, if necessary. This dynamic adjustment reduces wait times and ensures that customers receive timely and appropriate responses.

The technical operation of the computer is improved through the use of AI models that are specifically trained to understand speech, detect emotional cues, and determine optimal communication strategies. These models enable the system to perform complex tasks such as converting audio signals into text, analyzing intent and emotional states, and generating responses, all in real-time, or near real-time. This automation not only reduces the reliance on human agents but also allows the system to handle a higher volume of calls more efficiently.

Moreover, the system's ability to learn from past interactions through telemetry data, including temporal emotional state profiles, allows it to improve its performance and adapt to changing customer needs. This learning capability is a technical feature that enhances the system's ability to provide personalized service, reduce errors, and increase overall customer satisfaction.

In an example embodiment, the system includes a memory configured to store user profile data, prioritization rules, channel selection criteria, and operational instructions for a processor. Additionally, the system includes a processor operably coupled to the memory. The processor is configured to analyze a first audio signal of an incoming call to identify an intent of the call, selected from a set of intents, using operational instructions comprising an LLM trained to identify the intent, and to determine a priority level for the call based on the identified intent, the identity of the user, and the prioritization rules. In various cases, the prioritization rules include an established mapping between the set of intents, the identity of the user, and the priority level for the call. Furthermore, the processor is configured to determine, based on the determined priority level and the channel selection criteria, that the optimal communication channel for the call is a virtual audio chat channel. When communicating via the virtual audio chat channel, the processor is configured to receive a second audio signal from the user, convert the second audio signal into chat text, use the operational instructions comprising a virtual assistant (VA) LLM to process the chat text and generate a chat text output, convert the chat text output into an audio output using text-to-voice operational instructions, and transmit the audio output to the user in response to the second audio signal.

Some embodiments of this disclosure may include various aspects of the system and method that will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, where like reference numerals represent like parts.

FIG. 1A illustrates an interaction of callers with a call processing system, according to an embodiment.

FIG. 1B is a diagram of the call processing system shown in FIG. 1A, according to an embodiment.

FIG. 2 is a flowchart illustrating an example method for handling calls using the call processing system depicted in FIG. 1A, according to an embodiment.

### DETAILED DESCRIPTION

Various embodiments of the present disclosure will now be described more fully hereinafter with reference to the accompanying drawings, in which some, but not all, embodiments of the disclosure are shown. Indeed, the disclosure may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” can also be used herein.

### System for Processing Call Data and Selecting Channels for Responding to the Calls

Various embodiments of the present disclosure describe a system and method for processing call data and selecting appropriate channels for each call based on characteristics such as the intent, urgency, identity of the caller (whether a person, a group of people or an agency), and other relevant factors. In this disclosure, the term “call” is expanded beyond traditional audio transmissions to include any form of communication that involves data exchange, such as chat conversations via various applications, SMS, video meetings, emails, and similar interactions. The system and method are designed to handle call data in various forms, including audio and video, and can also process supplementary data such as text messages, attachments, documents, images, and other related content.

### Overview of the Systems for Exchanging Call and Response Data

In illustrative embodiments, a call processing system and method involve receiving transmitted data, such as call data, analyzing it to extract relevant information, determining an appropriate channel for communication, and then interacting with the caller through a suitable response agent, such as a computer-operated virtual assistant or a human agent. The call data originates from a “caller” (in this disclosure, “caller” and “user” can be used interchangeably) and is managed by a “responder” or “agent.” The caller can be an individual, a group, or another entity, such as an artificial intelligence agent or software application designed to transmit or generate data. For example, a “caller” could be a natural language processing (NLP) algorithm interacting with the system for data processing purposes.

The responder or agent can be any suitable entity selected by a call processing system capable of responding to the caller. For instance, the agent might be a person providing information to the caller or a virtual assistant, such as an Agent Voice Assistant (AVA), configured to generate audio responses to the caller's requests. In some scenarios, the AVA can work alongside human agents; for example, the AVA might handle straightforward questions, while more complex inquiries are addressed by a human agent during the call.

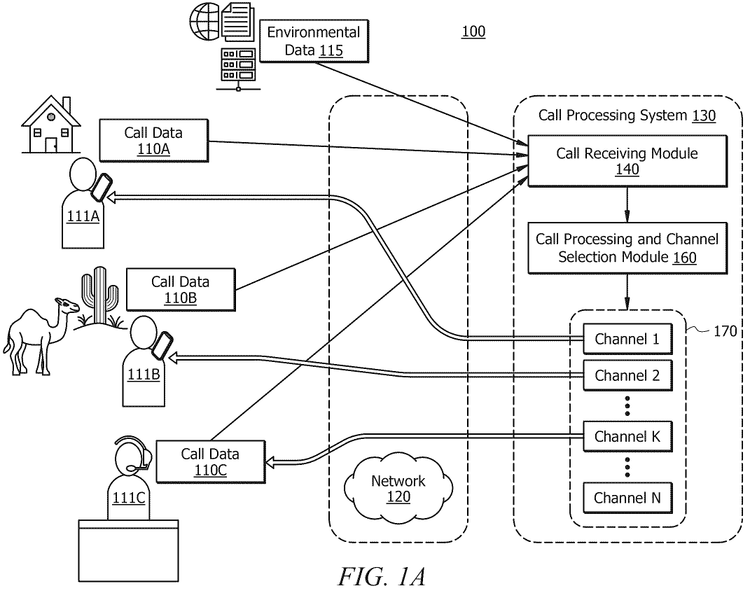

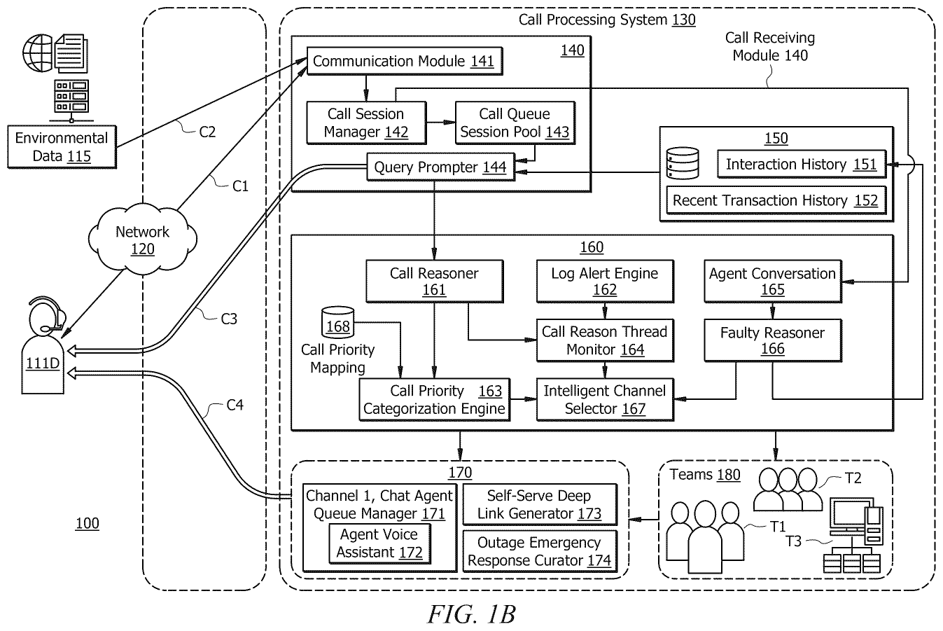

FIG. 1A illustrates an example environment 100, which includes various callers (111A-111C) and a network 120 that facilitates communication between these callers and a call processing system 130. Additionally, call processing system 130 can receive environmental data 115, which is also transmitted to call processing system 130 via network 120.

In various embodiments, the call processing system 130 can receive calls from different callers located in various settings, using a variety of call devices. For example, caller 111A may transmit call data 110A from a home environment, caller 111B may be calling from a remote outdoor location, such as a rural area with limited communication infrastructure, and caller 111C might be calling from an office with access to digital communication tools, such as a computer with internet access. The call processing system 130 is configured to handle any suitable call data, such as call data 110A-110C, which corresponds to the respective callers 111A-111C. For instance, call data 110A and 110B may include audio data, while call data 110C could comprise both audio and text data.

In various cases, call processing system 130 is configured to collect metadata associated with call data 110A-110C. This metadata can include a wide range of information to help prioritize calls more effectively. Various embodiments of the present disclosure utilize a call processing system configured to collect and analyze metadata associated with call data (e.g., call data 110A-110C) to determine the priority and routing of calls. The metadata may include, but is not limited to, the following:

Location Data: This includes the geographic location of callers (e.g., callers 111A-111C), such as whether a caller is in an urban area, a remote location like a desert, or a high-risk zone. For example, calls from remote or dangerous areas may be assigned a higher priority due to limited access to alternative communication methods.

Time of Day: The specific time at which the call is made can impact its priority. Calls made outside normal business hours or during emergencies, such as natural disasters or peak times, may be prioritized differently to ensure timely responses.

Caller Account Information: Metadata may include information about whether the caller has an account with an organization associated with call processing system 130, including the account status (e.g., high-value customer, unpaid account, or no account). Callers with significant accounts or linked to premium services might receive higher priority to enhance customer satisfaction and retention. The caller account information may include caller identification information such as the caller's name, date of birth, identification number, or password, which may be used to verify identity and assess urgency based on the caller's profile and interaction history with the agency. In some cases, the caller account information may include information about high-priority individuals or entities associated with the caller account. If a caller is associated with a person or entity deemed high priority, such as a high-value account holder or an important agency, their calls may be prioritized to ensure prompt attention. Further, the caller's account information may include social and demographic information. For example, metadata related to the caller's social and demographic context, such as, profession, or physical wellness status, can help determine the urgency and priority of the call. In contexts like emergency services, metadata indicating the caller's physical wellness status or safety concerns can be important. Calls indicating immediate risks or safety threats may be prioritized. Further, the caller's account information may contain information about the caller's accessibility needs. For example, metadata can identify if the caller has specific accessibility requirements (such as hearing or vision impairments), ensuring these calls are prioritized, and particular channels are selected to meet the accessibility needs of the client during the call. Additionally, metadata identifying whether the caller's account is linked with other accounts, such as family members or business partners can be used for determining the priority of the call. Calls from linked accounts may need prioritization to address shared concerns or issues comprehensively. If the caller is a member of a loyalty program, a VIP customer, or holds a membership with certain privileges, their calls might be prioritized to enhance satisfaction and retention.

Phone Number and Device Information: Information about the caller's phone number and device can provide insights into the caller's location and method of communication, potentially influencing the prioritization process.

Network Quality: The quality of the caller's network connection can be an important factor in prioritization. For example, calls from areas with poor connectivity might be assigned a higher priority to reduce the risk of dropped or interrupted communications. Additionally, real-time data on network congestion or system load that could impact service quality is also considered. Calls from highly congested areas may be prioritized to ensure they are completed successfully and are not affected by poor connection quality.

Movement and Urgency Assessment: Metadata derived from GPS data, which can be communicated as a part of call data, can indicate the speed and movement of the caller. A caller moving quickly (e.g., in a vehicle) may be in a more urgent situation compared to someone who is stationary, warranting higher priority. Furthermore, the caller in a vehicle may have access only to some channels (e.g., a phone communication) while not being able to access other channels (e.g., texting).

Current Global or Local Events: Metadata identifying whether the caller is in a region affected by global or local events, such as natural disasters, political unrest, or public emergencies, can be important. Calls from these regions might be prioritized due to the potential urgency or risk. Further, information about global or local events, or information associated with the organization associated with call processing system 130 can be further received via environmental data 115.

Environmental data 115 can provide information that enhances the call processing system 130's ability to prioritize and manage calls effectively. This data includes information about global and local events, such as natural disasters, political unrest, or public emergencies, which may require the system to prioritize calls from affected regions due to the increased urgency or risk. It also includes environmental conditions like severe weather alerts or hazardous situations, where calls from these areas may be deemed higher priority to ensure immediate response.

Additionally, data related to organizational alerts, such as service disruptions, financial policy changes, or internal updates, can influence call handling priorities by prompting faster responses to customers seeking clarification or assistance.

Alerts about identity theft, theft of account information, and credit card misuse can be important for swiftly addressing security breaches, thereby protecting customer assets and information. Information regarding changes in financial policies, such as alterations in interest rates or lending criteria, may necessitate prioritizing calls from customers needing urgent financial guidance or support.

Furthermore, indicators of a bank's financial instability or failure can trigger prioritization for calls from concerned customers about their accounts. Market issues, such as stock market volatility or currency devaluation, could affect customer investments and savings, prompting the system to prioritize calls for reassurance, guidance, or urgent transactions.

Economic data, including recession indicators or inflation rates, may also impact caller needs, requiring prioritization adjustments based on economic conditions. Data on infrastructure status, such as power outages or transportation disruptions, can inform call handling to address service needs in affected areas.

Geopolitical data on sanctions or trade policies can affect caller concerns, particularly those involving sensitive financial transactions or international dealings. Public service announcements, like evacuation orders or safety advisories, can further impact the urgency and handling of calls, especially in emergency contexts.

Furthermore, environmental data 115 related to network quality in a specific location, connectivity issues with the call processing system 130, and the availability of resources for the call processing system 130 (e.g., if web servers associated with the call processing system 130 are down) can be important for determining the priority of a particular call.

Language Preference and Proficiency: Metadata about the caller's preferred language and proficiency can help assign calls to agents who can communicate most effectively, potentially increasing the priority if language barriers are likely to cause delays or misunderstandings.

Time Since Last Successful Contact: The duration since the caller last successfully reached an agent or received satisfactory assistance can influence priority. A short gap might indicate escalating frustration or urgency.

Data Privacy and Security Sensitivity: Calls involving sensitive information, such as personal data or financial transactions, might be prioritized to ensure they are handled by appropriately trained agents to comply with regulations like General Data Protection Regulation.

Caller's Device Type and Operating System: Information about the type of device and operating system used by the caller can influence how calls are handled. For instance, if a caller is using a public or shared device, the call might be prioritized for quicker handling to minimize exposure to security risks. The device type also determines which communication channels are available. For example, a user with a rotary phone would be limited to an audio communication channel, while a user with a telegraph would be restricted to a text-based channel. Additionally, if a caller is using a device in a noisy public environment, such as a bar, a text messaging channel might be preferred to ensure clear communication. Similarly, if a caller is using a basic feature phone without internet access, only voice or SMS channels might be available. Conversely, a caller using a smartphone or computer with a stable internet connection could access multiple channels, such as video calls, chat, or email, depending on their needs and the situation's urgency.

Scheduled Appointments or Reservations: Metadata indicating if the caller has a scheduled appointment or reservation with the organization or is contacting the organization about a time-sensitive event. Such calls might be prioritized to ensure timely and relevant support.

Compliance and Regulatory Flags: Metadata that flags calls involving compliance or regulatory issues requiring immediate attention, such as complaints or disputes, to mitigate legal risks.

Service Level Agreement (SLA) Adherence: Metadata related to specific service level agreements that require calls to be answered within a certain time frame or handled in a particular manner. Calls approaching SLA deadlines might be prioritized to maintain compliance.

Presence of Co-Browsing or Screen-Sharing Requests: Metadata that identifies if a caller has initiated a co-browsing session or requested screen-sharing support, indicating a need for more immediate or detailed assistance.

Geofencing Alerts: Metadata that alerts the system if a caller is within a specific geofenced area, such as near a branch location or within a secure zone. This can help prioritize calls when the caller is in proximity to sensitive or high-security areas.

Multi-Channel Engagement History: Metadata tracking how the caller has engaged with multiple channels simultaneously or sequentially. For example, a caller currently chatting online while making a call may indicate a higher urgency or a need for expedited support.

Engagement in High-Value or Time-Sensitive Activities: Metadata indicating if the caller is currently engaged in high-value activities (such as stock trading) or time-sensitive actions (such as booking last-minute travel). Calls associated with these activities might be prioritized to prevent financial losses or missed opportunities.

Caller's Preferred Communication Channel: Metadata indicating the caller's preferred method of communication, whether by phone, email, chat, or other channels. Calls made through a less-preferred channel could signal a more urgent need and thus be prioritized.

Device Battery Status and Connectivity Issues: Metadata including information on the caller's device battery status and connectivity stability. Calls from devices with low battery or unstable connections might be prioritized to ensure they are completed before the caller disconnects.

In various cases, call data 110A-110C is transmitted via network 120 to call processing system 130. Network 120 may be any suitable type of wireless and/or wired network. Network 120 may or may not be connected to the Internet or public network.

Callers 111A-111C can communicate with call processing system 130 through designated caller devices. Such caller devices can be smartphones, laptops, desktop computers, or any other appropriate electronic devices (e.g., landline phones, smartwatches, etc.). Caller device may include components such as a processor, memory, and audio capturing devices such as a microphone and camera, a display, and network-related hardware and software components (e.g., Wi-Fi adapters, cellular modem, antennas, network software applications, wireless drivers, and the like) for transmitting call data 110A-110C to call processing system 130.

### Call Receiving Module

In various embodiments call data 110A-110C is configured to be received by a call receiving module 140 of call processing system 130. Call receiving module 140 is configured to set up a new call session when a call is received, ensuring that all necessary resources and systems are in place to handle the call. It also manages the termination of a session once the call is completed or disconnected, freeing up resources for other calls.

Call receiving module 140 is configured to collect the metadata associated with a call data and may determine, based on the received metadata, the appropriate initial routing of a call based on various factors, such as the type of call, caller information, and the availability of agents or automated systems. The initial routing may include, for example, routing the call to a human agent or to a system for determining an appropriate channel for the caller. If transfer to the human agent is performed, call receiving module 140 may be configured to record in a database record associated with an account of the caller a reason why this particular call is transferred to the human operator for future reference.

In some cases, call receiving module 140 may be configured to dynamically generate prompts or questions to determine the reason for the call. This module can also handle the initial stages of the call, while a call processing and channel selection module 160 manages communication throughout the call's duration. Further details about the processes and functions of call receiving module 140 are provided in the discussion related to FIG. 1B, as described below.

### Call Processing and Channel Selection Module

Call processing and channel selection module 160 is designed to further determine the contextual information of the call by analyzing various call data, such as metadata, context data, and emotional data associated with the call of a caller (e.g., caller 111A). Based on this analysis, which can include analyzing historical data associated with various calls of caller 111A (and/or historical data of other callers) call processing and channel selection module 160 selects the most appropriate communication channels to connect caller 111A. As discussed before, the metadata might include details like caller location, network quality, or previous call history, while context data could involve the caller's reason for contacting the system, and emotional data might assess the caller's tone or stress level. By integrating these diverse data points, call processing and channel selection module 160 ensures that each caller is directed to the most suitable channel, whether that be a live agent, a virtual assistant, or another appropriate resource, to effectively address their needs. In various cases, besides using metadata associated with call data 110A of caller 111A, contextual information extracted from call data 110A (and/or previous call data associated with caller 111A) for determining priority and/or channel selection for caller 111A can include the following:

Frequency and Urgency of Calls from the Same Location: Call processing and channel selection module 160 may track the number of calls originating from the same location and assess their urgency. If multiple urgent calls are made from a disaster zone or similar high-priority area, new calls from that location may automatically receive higher priority.

Repeated Contact Attempts: Call processing and channel selection module 160 can monitor the number of times a caller has attempted to contact the agency. Frequent attempts without resolution may result in escalated priority to address the issue more effectively.

Success Rate of Previous Interactions: The outcomes of previous calls within a certain timeframe can influence the priority of subsequent calls. If prior interactions have been unsuccessful or unresolved, future calls might be prioritized to improve customer satisfaction.

Sentiment Analysis of Previous Interactions: Data derived from sentiment analysis of past calls can provide insights into the caller's emotional state. A caller who has shown signs of distress or dissatisfaction in previous interactions may be prioritized for faster handling.

Call Keywords Indicators: Real-time analysis of the call content can detect keywords or phrases indicating high urgency, such as “urgent,” “emergency,” or “help needed immediately,” which may prompt a higher priority response.

Caller's Historical Behavior: Patterns in the caller's past behavior, such as typical call times, frequent topics of concern, or recurring issues, can be analyzed. Deviations from these patterns may indicate a higher priority need. Also, information on the frequency and duration of past calls from the same caller can provide context. A caller who typically has short calls but is now engaged in a longer call may have a more complex or urgent issue requiring immediate attention

Cross-Channel Interaction History: Data on the caller's interactions across different channels (e.g., email, chat, social media) can provide additional context. If a caller has unsuccessfully tried to resolve an issue through other channels, their phone call may be prioritized.

Emotional Tone and Stress Detection: Advanced machine learning model (MLM) techniques can analyze the caller's voice for emotional tone, stress levels, or signs of agitation. High-stress levels may indicate urgency and prompt a higher priority response.

Behavioral Biometrics: Voice biometrics or other behavioral indicators (such as typing speed in digital interactions) can detect if the caller is under duress, suggesting an emergency situation that warrants higher priority.

Predicted Call Outcome: Predictive analytics can evaluate the likelihood of a positive or negative outcome for a call by analyzing historical data. Calls that are predicted to require escalation or have a high potential for customer dissatisfaction can be prioritized to ensure a swift and effective response. Additionally, the system can use data to anticipate a caller's future actions based on their past behaviors and interactions. For instance, if the system detects a high likelihood that a customer might end their relationship with the company due to previous negative experiences, their current call could be prioritized to proactively address their concerns and encourage customer retention.

The predicted call outcome can be measured through a predicted customer satisfaction score. This score is calculated based on the satisfaction ratings from previous interactions with the customer. Factors such as the customer's feedback, resolution time, and issue recurrence are analyzed to generate this score. Callers with historically low satisfaction scores might be given higher priority to enhance their experience and prevent additional dissatisfaction, ultimately improving overall customer satisfaction and loyalty.

As an example the customer satisfaction score may be calculated as a weighted average of various factors such as feedback score (FS), resolution time (RT), issue recurrence (IR), communication satisfaction (CS), and effort coefficient (EC) as follows:

$$Satisfaction Score ( SS ) = w 1 FS + w 2 RT + w 3 IR + w 4 CS + w 5 EC$$

Here, weights w1, w2, w3, w4, w5 are assigned to each factor, indicating their relative importance in determining overall satisfaction, and are configured to sum up to one. The Feedback Score (FS) can be directly derived from customer surveys, by asking a caller to rate their satisfaction on a scale (e.g., 1 to 10). The Resolution Time (RT) refers to the average time taken to resolve the customer's issues in past interactions; shorter resolution times tend to positively impact the satisfaction score, while longer times may negatively affect it. The RT can be measured in seconds or minutes. The Issue Recurrence (IR) measures how frequently the same or similar issues have been reported by the customer. A higher Recurrence Rate (RR) may suggest unresolved problems, thereby reducing satisfaction, and this factor could be inversely proportional to the IR, and thereby to the satisfaction score. For example, IR may be proportional to 1/RR. The Communication Satisfaction (CS) is derived from sentiment analysis of call transcripts, emails, or chat logs, evaluating the quality and tone of communication. Positive sentiments typically increase the CS, while negative sentiments may decrease it. Finally, the Effort Coefficient (EC) measures how much effort the customer had to expend to resolve their issue, assessed by the number of contacts made, transfers between agents, or steps needed to reach a resolution. Lower effort generally leads to higher satisfaction, making this factor inversely weighted in the satisfaction score calculation. It should be noted that the satisfaction score as described above is only one way for computing such a satisfaction score, and any other suitable rule-based or machine learning approach can be used.

Interaction Complexity: An analysis of the expected complexity of the call based on previous interactions, current metadata, or pre-call data (such as form submissions). Complex issues may be prioritized and handled by more experienced agents or higher-level support.

Device and App Usage Patterns: Data indicating how frequently and effectively a caller uses the organization's mobile app or online services. A customer with high usage may be prioritized to maintain satisfaction and encourage continued use.

Call Context Based on Recent Transactions or Events: Data that includes the context of the caller's recent transactions or interactions with the organization. For instance, a caller who has recently made a large transaction or changed account settings may be flagged for priority handling due to potential security concerns or the need for additional verification.

Connection with Automated Systems or Bots: Data identifying whether the caller is interacting with automated systems or bots before human contact. This can help determine if the caller's issue can be resolved without escalation or if the automation failed and requires immediate human intervention.

Caller Sentiment Trends Over Time: Data tracking sentiment trends across multiple calls over time. A trend showing increasing frustration or negative sentiment may trigger a higher priority for the current call to prevent escalation.

Current Wait Time and Historical Patience Level: Data considering the current wait time for the caller and their historical patience level (e.g., how long they typically wait before hanging up). A caller who has previously demonstrated low patience might be prioritized to reduce the likelihood of call abandonment.

Interaction with Third-Party Services: Data indicating whether the caller has recently interacted with third-party services or partners associated with the organization. Calls involving third-party interactions might require higher priority to resolve issues that could affect multiple stakeholders.

Internal Alerts and Flags: Metadata involving internal alerts or flags set by customer service agents or systems based on previous interactions, indicating that a specific caller requires special attention or handling.

Caller's Recent Engagement with Informational or Support Content: Data tracking if the caller has recently engaged with informational materials, FAQs, or other support content provided by the organization. If a caller has reviewed relevant content and still calls in, their query might be prioritized as it indicates the need for more in-depth assistance.

Unauthorized or Suspicious Activity: Data tracking customer accounts for signs of unauthorized or suspicious activity. This might include transactions that are flagged as potentially alarming, such as unusual spending patterns, large transfers, or activities that deviate significantly from a customer's typical behavior. The system is set up to detect these anomalies in real time. If such activity is detected, the call can be prioritized. For example, If a caller whose account has been flagged for suspicious activity attempts to contact the organization associated with the caller's account, call processing system 130 can be configured to use this information to prioritize the call. Such prioritization ensures that these calls are moved to the front of the queue, ahead of less urgent queries. This is crucial in time-sensitive situations where swift action is needed to prevent financial loss or mitigate potential misuse. Given the urgency of such situations, the system can bypass automated response systems and route the customer directly to a human agent who can provide immediate assistance. This is especially important for scenarios where customers need reassurance or need to take quick actions, such as freezing accounts, reversing unauthorized transactions, or receiving detailed guidance on securing their accounts.

Upon determining the priority of a call based on metadata, call context data and emotional data, call processing and channel selection module 160 is configured to select the most appropriate channel for ongoing communication with the caller (e.g., caller 111A). It should be noted that at any point during the call, call processing and channel selection module 160 can re-evaluate the call's priority and re-assign the caller to a different channel as needed. For example, if a caller has been assigned to a human operator channel and has been waiting for a certain period, the module can re-evaluate the call's priority and reassign it to a different channel, such as a human agent-operated chat channel, to ensure a more efficient response.

FIG. 1A shows various available channels that are indicated by channels 1-N. For example, as shown in FIG. 1A, channel 1 may be used for communicating with caller 111A, channel 2 may be used for communicating with caller 111B, and channel K may be used for communicating with caller 111C. The types of available channels can include:
An audio channel with a human agent, allowing for real-time, voice-based communication.
A chat channel operated by a human agent, providing text-based interaction through messaging.
An audio channel with a virtual assistant capable of providing automated voice responses and conducting interactive conversations.
A video channel with a human agent, enabling face-to-face communication for a more personalized interaction.
A video channel with a computer-generated avatar representing a virtual assistant, offering visual representation and voice responses in an automated format.
An SMS channel for text messaging, allowing for concise, asynchronous communication, often used for confirmations, updates, or alerts.
An email channel, which enables detailed, text-based communication suitable for sharing documents, instructions, or more complex inquiries.
A co-browsing channel, where a human agent or virtual assistant can share a screen with the caller to guide them through online processes or troubleshoot issues.
A social media channel, allowing interactions through platforms like Twitter or Facebook, where customer service agents or automated bots can handle inquiries.
An interactive voice response (IVR) channel, which uses automated prompts and keypad inputs to navigate menus and access specific services or information.
A Self-Serve Deep Link Generator configured to create direct links (deep links) to specific self-service options or functionalities.
An Outage/Emergency Response Curator is designed to manage both automated and, in some cases, human-operated communications and responses during outages, emergencies, or other critical events.

FIG. 1B provides additional details of call processing system 130 within environment 100. Similar to the diagram in FIG. 1A, call processing system 130 is accessible to callers, such as caller 111D, through network 120. For instance, caller 111D may interact with communication module 141 via call channel C1. Additionally, environmental data 115 can also be communicated to communication module 141 via channel C2. Call processing system 130 oversees the entire call management process by integrating various modules to streamline operations. Initially, calls are routed to call receiving module 140, which includes communication module 141 responsible for handling initial interactions with callers and setting up the necessary call sessions. Communication module 141 is connected to call session manager 142, which oversees active call sessions, ensuring each call is properly managed throughout its lifecycle, from initiation to completion. For example, call session manager 142 is configured to monitor call status, handle interruptions, and ensure that calls are escalated or terminated as required.

Calls that are not immediately managed by the system are placed in the call queue session pool 143, which serves as a temporary holding area for calls awaiting assignment to the appropriate agent or communication channel. During this waiting period, query prompter 144 can dynamically generate questions or prompts aimed at understanding the caller's intent. For example, if a caller asks about account security, query prompter 144 might generate clarifying questions such as, “Are you calling to report a suspicious transaction?” or “Would you like assistance with enhancing your account security settings?” These additional questions help gather the information to direct the call to the most suitable resource or agent. The communication generated by query prompter 144 can be sent to caller 111D through communication channel C3. In cases where caller 111D is communicating with call processing system 130 using audio data, query prompter 144 can utilize an appropriate text-to-voice application to convert text prompts into voice data, ensuring they are effectively transmitted to caller 111D.

In various embodiments, as detailed above, call receiving module 140 is responsible for the initial intake and processing of calls. It gathers essential caller information and analyzes preliminary data to inform subsequent handling decisions. This module can transmit call data to be stored in interaction history 151 and recent transaction history 152, which archive historical data on previous interactions and transactions. This historical data can be stored in database 150 and can be valuable for the query prompter 144, enabling it to generate more relevant clarifying questions based on the caller's past interactions and transaction history. For example, if a caller has a history of frequent password resets, the system might prioritize questions related to account recovery or security settings.

### Large Language Model for Implementing Query Prompter

The query prompter 144 can be implemented using a Large Language Model (LLM), which leverages advanced machine learning techniques to understand and generate human-like text based on vast datasets. One of the most effective architectures for such models is the transformer, which utilizes a bi-directional attention mechanism to understand the context and relationships between words in a sentence. Unlike traditional recurrent neural networks (RNNs) that process sequences in a linear order, transformers use a self-attention mechanism that allows the model to weigh the importance of different words in a sequence regardless of their position. This is particularly powerful for understanding context because it enables the model to consider all words in a sentence simultaneously, rather than sequentially. The bi-directional attention component further enhances this capability by processing the input text from both directions-forward and backward-allowing the model to capture dependencies that may span the entire sentence or paragraph. This is crucial for understanding complex language structures and subtleties, such as those often found in customer interactions.

To effectively process text, transformers can be configured to convert words into high-dimensional vectors known as embeddings. These embeddings capture semantic meanings and relationships between words by mapping them to continuous vector spaces where similar words have similar vector representations. This allows the LLM to understand not just the meaning of individual words but also how they relate to one another in different contexts. Additionally, since transformers do not inherently capture the order of words, positional encodings are added to the embeddings to provide information about the relative or absolute position of words in the sequence. This ensures that the LLM retains an understanding of word order, which is essential for interpreting the grammatical structure of sentences.

Within the transformer architecture, the multi-head attention mechanism allows the model to focus on different parts of a sentence simultaneously. Each “head” in the multi-head attention mechanism independently computes a different set of attention weights, allowing the model to capture a variety of linguistic features and relationships at multiple levels. For example, one head might focus on the relationship between a subject and a verb, while another head might capture dependencies between an adjective and a noun. This parallel processing capability enables the LLM to develop a comprehensive understanding of the text, enhancing its ability to generate contextually appropriate prompts.

After the attention mechanisms, the transformer architecture uses feed-forward neural networks to further process the attention output. These networks consist of multiple layers of fully connected neurons that transform the input data, introducing non-linearity and enabling the model to learn complex patterns. Layer normalization is applied to stabilize the learning process, ensuring that the distribution of inputs to each layer remains consistent throughout training. This normalization helps the model converge faster and perform more reliably, especially in deep architectures with many layers.

In various cases, the LLM is trained on a corpus of historical call data, which includes transcripts, chat logs, emails, and other text-based communications. The training process involves supervised learning, where the model learns to predict the next word or phrase in a sequence given the preceding context. This task, known as language modeling, allows the LLM to develop a nuanced understanding of language patterns, syntax, and semantics. Fine-tuning on domain-specific data, such as banking or customer support interactions, further refines the model's ability to generate relevant and accurate prompts based on the caller's input.

Historical call data can include indicators of whether a call was successful or not. Success can be determined by various metrics such as customer satisfaction scores, resolution rates, the absence of repeated calls for the same issue, or the achievement of specific call objectives, like completing a transaction, resolving a query, or confirming a security setting. This success indicator can be explicitly labeled in historical data and used to guide the training of the LLM. By associating successful calls with the prompts and responses that led to positive outcomes, the model can learn which types of questions are most effective in resolving particular issues or concerns.

Moreover, historical call data contains rich contextual information that can be analyzed for sentiment and emotional tone. By using sentiment analysis, the LLM can be trained to recognize the emotional state of the caller, such as frustration, confusion, or urgency. This information can guide the model to generate prompts that are empathetic and tailored to the caller's emotional state, thereby improving the overall customer experience. For example, if the sentiment analysis indicates that the caller is distressed, the LLM can be trained to generate calming and reassuring prompts.

In various embodiments, calls typically follow a structured dialogue pattern, starting with a greeting, followed by the caller stating their issue, the agent asking clarifying questions, and finally, the resolution of the issue. These patterns provide valuable insights into effective communication strategies. The LLM can be trained on these sequential patterns to understand the flow of a conversation and generate contextually appropriate prompts at each stage of the call. For instance, if the call data shows that certain follow-up questions are effective after specific types of initial inquiries, the model can learn to replicate this strategy.

Historical call data often includes information on different resolution techniques and strategies employed by human agents. By analyzing this data, the LLM can learn which techniques are most successful for different types of inquiries or issues. This can include understanding when to escalate a call, when to offer alternative solutions, or when to provide detailed explanations versus brief answers. Training the model on these strategies helps it to generate more effective prompts and responses that mimic successful human-agent behavior.

In addition, call data often comes with metadata such as the time of the call, the caller's location, device type, network quality, and account status. This metadata can provide additional context that the LLM can use to tailor its prompts. For example, if the metadata indicates that a caller is using a mobile device in a low-connectivity area, the model can prioritize prompts that offer quick and concise solutions to minimize call duration and the risk of disconnection.

The interaction history 151 and recent transaction history 152 components provide a wealth of historical data unique to call-related interaction that can be used to train the LLM. By examining previous interactions with various callers, as well as with a specific caller, the model can learn about that specific caller's preferences, past issues, and typical responses. This historical data enables the model to anticipate the caller's needs and generate personalized prompts that are more likely to lead to a successful resolution.

In various embodiments, historical call data may include feedback information, such as post-call surveys or real-time feedback collected during the call. This data offers direct insights into the effectiveness of the conversation and can be used to refine the training of the LLM. For example, if certain prompts consistently receive negative feedback, the model can be retrained to modify or avoid using those prompts in future interactions. Additionally, prompts generated by the query prompter 144 may include specific feedback requests to enhance future training of the LLM. These prompts can be presented to the caller, especially when there is an indication that the call was unsuccessful. In such scenarios, the prompts may ask the caller to identify the reasons for the unsatisfactory interaction and suggest what could be improved in future interactions. Conversely, even when an interaction is deemed successful, a prompt can still be offered to the caller to inquire about the particular aspects of the response that contributed to a positive experience. This feedback mechanism helps continually refine and improve the LLM's performance by incorporating caller feedback into its training process.

In various cases, the call data can also be domain-specific, containing terminology, jargon, and common issues unique to a particular industry, such as banking, clinical care, or tech support. The LLM can be trained to recognize and understand this domain-specific language, allowing it to generate more relevant and accurate prompts. For example, in a banking context, the model could be trained on calls dealing with account management, misuse detection, loan inquiries, and more, learning the appropriate language and response strategies for each type of call.

By using a continuous feedback loop where the LLM's generated prompts are monitored for effectiveness based on call outcomes, the model can be incrementally improved. This means that the LLM not only learns from the initial training data but also adapts over time to the evolving nature of customer interactions and preferences. For example, if a new issue type emerges, like a new type of misuse, the model can quickly learn from successful resolutions of similar calls to handle future cases more effectively.

Furthermore, call data can indicate when automated systems successfully resolved an issue versus when a call required human intervention. This information can be used to train the LLM to better identify when to continue with automated prompts and when to escalate to a human agent, thereby improving the overall efficiency of the call processing system. By leveraging these unique aspects of call data, the LLM can be effectively trained to understand the nuances of customer interactions, generate more precise and helpful prompts, and ultimately enhance the call handling process, leading to higher customer satisfaction and more efficient use of resources.

### Intent Recognition During a Call

In various embodiments, during a call, the LLM uses its trained understanding of language to recognize the caller's intent. This involves analyzing the sequence of words and phrases to determine the most likely category or topic of the call, such as “account inquiry,” “technical support,” or “alert.” The LLM then generates prompts or questions that are specifically tailored to the identified intent, helping to clarify the caller's intent and providing the system with additional information to make informed decisions about call handling. For example, if a caller mentions “unauthorized charges,” the LLM might generate prompts like, “Would you like to discuss recent transactions that led to the unauthorized charges?” or “Are you interested in learning more about our protection options?” By employing these advanced machine learning techniques, the LLM-based query prompter 144 enhances the call processing system's ability to understand and respond to customer inquiries dynamically and effectively.

In certain instances, query prompter 144 may utilize the LLM to identify the caller's intent and generate relevant prompts accordingly. Alternatively, the LLM can be triggered by call session manager 142 to evaluate the underlying intent of the call. For example, if call session manager 142 employs the LLM to determine that the call is urgent, it may redirect the call to the agent conversation 165 component, allowing for direct interaction with a human agent.

### Call Processing and Channel Selection Module

After determining the intent of the call, query prompter 144 may hand over the call to the call processing and channel selection module 160. In particular, the query prompter 144 can provide the relevant call data to the call reasoner 161. The call reasoner 161 is designed to analyze the incoming call data, which includes metadata, contextual information, and emotional cues, to evaluate the priority of the call using a call priority categorization engine 163. The call priority categorization engine 163 utilizes the intent of the call, metadata associated with the call, and various contextual information extracted from the current call and any previous calls made by the same caller, to assign a priority level to the call.

The determination of priority can be achieved by applying prioritization rules that map various aspects of the call to specific priority levels. These prioritization rules can be implemented using either a rule-based approach or a machine learning-based model. The rule-based approach is a mapping that includes a set of predefined rules establishing call priority. These rules are formulated based on an understanding of which factors are most critical for prioritizing calls. For example, rules may determine that calls from high-value customers, calls flagged with urgent keywords like “emergency” or “misuse,” or calls originating from locations experiencing ongoing events (e.g., natural disasters, outages) are assigned higher priority.

The rule-based approach mapping can be implemented using a decision table, where predefined rules are listed in a structured format. This table defines how different combinations of call attributes (such as intent, user identity, metadata, and contextual information) map to various priority levels. Each row in the table represents a specific rule or condition, and the priority level assigned to a call is determined by matching its attributes to these rules.

The following Table 1 below provides an example rules for determining call priority based on a set of criteria:

TABLE 1

| Rule | | User | Location | Urgency | Call | Priority |
|---|---|---|---|---|---|---|
| Number | Intent | Identity | Context | Indicator | Frequency | Level |
| 1 | Account | High-Value | No specific | High | Low | High |
| | Security | Customer | context | | | |
| 2 | Technical | Regular | Urban Area | Medium | Medium | Medium |
| | Support | Customer | | | | |
| 3 | Emergency | Any | Disaster | High | Any | Highest |
| | Alert | | Zone | | | |
| 4 | General | Any | Any | Low | High | Low |
| | Inquiry | | | | | |
| 5 | Misuse | Any | High-Activity | High | Any | Highest |
| | Detection | | Location | | | |
| 6 | Payment | High-Value | Any | Medium | Low | High |
| | Issue | Customer | | | | |
| 7 | New | New | Rural Area | Low | Low | Medium |
| | Account | Customer | | | | |
| | Setup | | | | | |

In Table 1, the rule number provides a unique identifier for each rule, making it easy to reference and update as needed. Intent specifies the main reason for the call, such as “account security,” “technical support,” or “emergency alert.” Further, user identity categorizes callers based on their identity or relationship with the organization, such as “high-value customer,” “regular customer,” “new customer,” or “at-risk customer.” Location context includes the geographic or situational context of the call, such as “disaster zone,” “urban area,” “high-activity location,” or “rural area.” Urgency indicator reflects the urgency level of the call, which could be determined by specific keywords, phrases, or metadata indicators like “high,” “medium,” or “low.” Call frequency captures the frequency of calls from the same caller or location, categorized as “high,” “medium,” or “low.” High frequency might indicate a recurring issue that requires attention. Priority level determines the overall priority assigned to the call based on the criteria in the other columns. Priority levels could range from “low” to “highest,” indicating how urgently the call should be handled.

In a machine learning approach, the system uses a model that has been trained on historical call data to predict call priority based on various inputs. This involves creating a feature set that includes intent, user identity, metadata, and context-related data. Each piece of information is transformed into a numerical format suitable for the machine learning model. The input data for a machine learning model can be composed of various features extracted from the call data. For instance, intent can be encoded as categorical variables, user identity information can be anonymized and represented using hashed identifiers, and metadata such as call location, time, and device type can be included as additional features. Other context-related data, such as the frequency of calls or the number of unresolved issues, can also be captured as numerical or categorical features.

In various cases, contextual information, especially textual data like notes from previous calls or keywords identified during the conversation, can be converted into word embeddings using natural language processing techniques. Word embeddings are dense vector representations of words or phrases that capture semantic meaning in a format that can be utilized by machine learning models. For example, a word embedding model like Word2Vec or a contextual embedding model like BERT can be used to convert textual data into vectors. These vectors then serve as input features, enabling the model to leverage the semantic information present in the text to make more accurate priority predictions.

The priority determining machine learning model (P-MLM), which could be a decision tree, random forest, gradient boosting machine, or neural network, is trained on labeled historical call data where the priority level is known. The P-MLM learns to associate specific patterns in the input data (intent, user identity, metadata, contextual information) with the priority outcomes. Through this training process, the model develops an understanding of how different features influence call priority.

Once trained, the P-MLM can predict the priority level of new calls in real-time. When a new call is received, the relevant data is processed to form the input features, which are then fed into the P-MLM. The P-MLM outputs a predicted priority level, which informs how the call is handled by call processing system 130.

By utilizing either rule-based mapping, probabilistic machine learning models (P-MLM), or a weighted combination of both, the call processing system 130 effectively prioritizes calls based on the most relevant factors, thereby enhancing the responsiveness and efficiency of the call handling process. The call priority mapping can be managed by the call priority mapping component 168, which interacts with the call priority categorization engine 163. In some instances, such as when call prioritization is facilitated by machine learning models, the call priority mapping component 168 can be integrated into the priority categorization engine 163.

In various cases, call processing and channel selection module 160 can include log alert engine 162 for monitoring system alerts or issues that could impact call processing, ensuring any technical problems are promptly addressed. Log alert engine 162 is communicatively coupled with call reason thread monitor 164 configured to proactively monitor backend systems and application logs for any technical issues that could affect customer service. It continuously checks for failures, such as problems with transaction processing or other critical banking functions. When a caller contacts the organization associated with call processing system 130 with a complaint, such as a missing transaction, the call reason thread monitor 164 can identify whether this issue is related to a known system problem by correlating the customer's reason for calling with the data it has collected. This allows call processing system 130 to quickly determine if the problem is isolated or part of a broader issue affecting multiple customers. If a widespread problem is detected, the call reason thread monitor 164 can trigger automated responses to inform callers of the issue and provide guidance, or it can escalate the case to human agents if immediate intervention is needed.

Additionally, it can coordinate with other systems, like an intelligent channel selector 167 or to ensure the bank responds efficiently and minimizes customer impact. Overall, call reason thread monitor 164 helps maintain service quality by quickly identifying and addressing issues, thereby reducing customer frustration and preventing small problems from becoming larger service disruptions.

Once the call's priority is determined, the call priority categorization engine 163 assigns a priority level based on the analyzed data. This prioritization informs intelligent channel selector 167, which decides the most appropriate communication channel for the call, such as a chat with a human agent, a voice response from a virtual assistant, or video communication. For instance, a high-priority call might be routed directly to a live agent, while a lower-priority inquiry could be handled by a virtual assistant.

FIG. 1B further shows agent conversation 165 component designed to facilitate direct interaction between a caller (e.g., caller 111D) and a human agent associated with call processing system 130. Agent conversation 165 establishes the call with the human agent for high priority calls (e.g., emergency calls, and the like) or when human agents are available. Agent conversation 165 can also utilize historical interaction data and contextual information to enable the agent to better understand the caller's needs and resolve issues more efficiently.

In various embodiments, agent conversation 165 is communicated with faulty reasoner 166 configured to detect and manage anomalies or errors within the call reasoning process. Faulty reasoner 166 is configured to continuously monitor customer interactions to determine why certain calls are escalated to a live agent. It plays an important role in identifying issues within automated processes or customer interactions by analyzing both current and historical data to assess what went wrong during different calls. Faulty reasoner 166 then sends this information to a database containing interaction history 151, which can subsequently be used as data to refine and improve future interactions.

Call session manager 142 is responsible for the management of the call session. It handles incoming calls and directs them through the system for processing. When a call is identified as needing direct human interaction or if there is an issue in determining the correct channel or resolving the call, call session manager 142 can route the call to agent conversation 165. In some cases, call session manager 142 can route the call to agent conversation 165 based on the intent of the call, which can be determined by the LLM, as described above. After completion of the conversation with the human agent via agent conversation 165, call-related information can be sent to a faulty reasoner 166.

As shown in FIG. 1B, after the call information has been processed by faulty reasoner 166, faulty reasoner 166 is configured to interact with intelligent channel selector 167 to further select a channel (after, for example completing at least some of the call interaction with the human agent when connecting to agent conversation 165). For example, after faulty reasoner 166 processes ambiguities in the call data that prevent clear determination of the call's intent or priority, it can flag these issues and communicate them to the intelligent channel selector 167.

In various embodiments, intelligent channel selector 167 is configured to select a channel from channels 170 for communication with a caller (e.g., caller 111D). In various embodiments, intelligent channel selector 167 can continually assess and reassess appropriate channels for a call throughout its duration.

Channels 170 represent various communication pathways available for handling calls based on identified priority, intent, user identification, and other metadata or contextual information. Different channels can be employed depending on these factors. For example, channel 1 can be represented by a chat agent queue manager 171 channel, which is designed to manage chat interactions with both human agents and automated voice assistants. When a call involves text communication through a chat interface, such as SMS, the chat agent queue manager 171 channel queues these calls for response through the same chat interface.

In addition, the chat agent queue manager 171 channel can handle voice calls containing audio signals. When such voice calls are received, the chat agent queue manager 171 channel can utilize a suitable audio-to-text transcriber to convert the audio signals into text transcripts. This transcription process can involve several technical steps. First, the audio signal is digitized and preprocessed to remove noise and enhance clarity. Then, the digitized audio is segmented into smaller units, such as phonemes, using techniques like short-time Fourier transform (STFT) or mel-frequency cepstral coefficients (MFCCs) to capture the unique characteristics of the sound.

A speech recognition model, often based on deep learning architectures like recurrent neural networks (RNNs), long short-term memory networks (LSTMs), or transformers, is then applied to these segments to predict the corresponding text. This model is typically trained on large datasets of paired audio and text to learn the relationships between spoken language and written text. The resulting text transcript can then be analyzed by the LLM to determine the call's intent and context, allowing the system to generate appropriate responses or further actions.

For each particular caller, a specialized model can be trained based on that caller's historical data to enhance the accuracy and relevance of responses. This personalized approach allows the system to adapt to the unique patterns and preferences exhibited by individual callers over time. By leveraging past interactions, the speech recognition model can learn the specific nuances of the caller's speech, typical inquiries, emotional tone, and preferred communication style.

After converting the audio signal into a text transcript, this text transcript can be passed to the agent voice assistant 172, which may utilize a virtual assistant (VA) LLM configured to provide responses in the form of a text output based on the content of the text transcript. In some scenarios, the LLM used by the agent voice assistant 172 could be the same model employed by other components of the call processing system 130, such as the call session manager 142 or the query prompter 144. Alternatively, a distinct LLM might be specifically trained to address typical caller requests during calls, ensuring more specialized and effective responses.

Furthermore, depending on the call's intent, a specialized LLM can be chosen from a set of expert models. For instance, if the intent of the call is related to setting up a new account or conducting financial transactions, a first LLM trained specifically for these purposes might be engaged. Conversely, if there is an indication of unauthorized access to an account, a different LLM, trained to handle security breaches and account protection, could be deployed. This approach allows for the selection of the most suitable model tailored to address specific issues effectively, enhancing the accuracy and relevance of the responses provided during the call.

After the text output by the LLM has been generated in response to the request represented by the text transcript, the text output can be converted to audio output using a text-to-speech (TTS) module. The TTS module can use any suitable approach for synthesizing speech based on the text output. For example, the TTS module can analyze and preprocess text output, breaking it into smaller units like sentences or phrases and handling elements such as punctuation, grammar, abbreviations, and context-specific terms. It then applies linguistic rules to convert text into phonemes, the smallest units of sound, using a lexicon or machine learning models to ensure accurate pronunciation. The system also generates prosody, determining the rhythm, stress, and intonation of speech to convey naturalness and emotion. Using the prosody information (e.g., information related to rhythm, stress, intonation, pitch, duration, and intensity of the spoken language), the TTS module then produces audio output from the text output. The audio output is then transmitted to caller 111D via a communication channel C4, as shown in FIG. 1B.

If a caller has a preference for a certain voice, which can be determined by historical data showing successful interactions with that voice, the TTS module can be configured to use that specific voice for future interactions. By analyzing past call data, the system can identify which voice characteristics, such as tone, pitch, or accent, led to positive experiences and outcomes for the caller.

In various cases, chat agent queue manager 171 channel implemented by means of an agent voice assistant 172 is referred to as a virtual audio channel. Such a virtual audio channel can be one of many channels available to the caller that can be selected by intelligent channel selector 167. In some cases, other channels can be selected. For example, a human agent can be selected, a self-serve deep link generator 173 channel can be selected or outage emergency response curator 174 can be selected.

Self-serve deep link generator 173 is configured to provide callers with direct access to self-service options, often through links sent via SMS, email, or other digital means. It is used when the call system determines that the caller's needs can be met through online resources or self-help tools.

Outage emergency response curator 174 can be designed to handle calls during outages, emergencies, or other critical events. It ensures that communication is streamlined, and that information is relayed efficiently during situations that require immediate attention or mass communication efforts.

Other channels can include email, SMS, video stream, or any other suitable communication pathways for supporting interaction between caller 111D and call processing system 130.

In addition to selecting channels, the intelligent channel selector 167 can be configured to choose a specific group or team from teams 180 to respond to a caller through channels 170. A team can be a specialized unit designed to handle a particular type of call. For example, a specialized team (e.g., team T1, as shown in FIG. 1B) is dedicated to monitoring customer accounts for unauthorized activities. Team T1 is specifically trained in detection and prevention of account breaches, constantly overseeing accounts for any signs of suspicious or unauthorized behavior. When potential misuse is detected, team T1 is selected to communicate with the customer through various channels 170, such as email, text, or push notifications. Other teams may be dedicated to different aspects of customer interactions within the call processing system 130. For example, team T2 could be dedicated to assisting customers with securing loans through an organization associated with the call processing system 130, while team T3 might focus on providing customer support for technical issues or account management. In some cases, teams can be composed of human agents, virtual assistants, or a combination of both. For instance, as indicated in FIG. 1B, team T3 may consist of virtual assistants implemented as LLMs, utilizing various computing resources. As indicated by an arrow between teams 180 and channels 170 in FIG. 1B, teams 180 can engage with the caller 111D via channels 170.

Methods for Processing and Handling a Call with a Caller

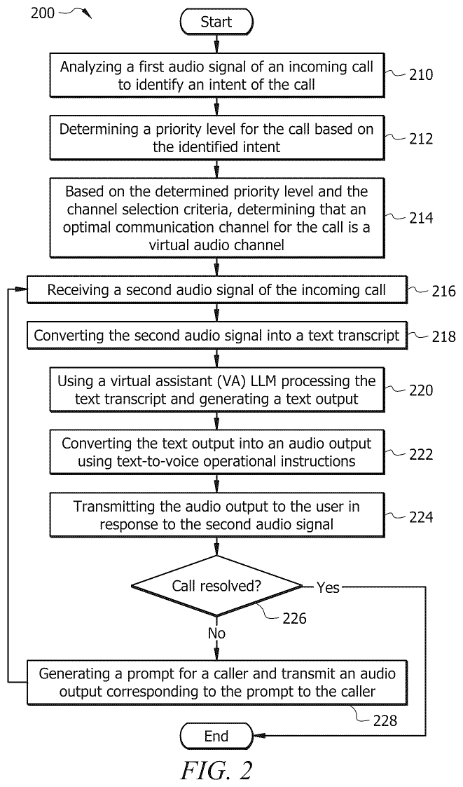

FIG. 2 shows an example method 200 of processing and handling a call with a caller. Method 200 includes a series of operations 210-224 to efficiently handle incoming calls by analyzing intent, determining priority, selecting the optimal communication channel, and providing responses using a virtual assistant. Various operations of method 200 are performed by call processing system 130.

At operation 210 the method includes analyzing the first audio signal of an incoming call to identify the intent of the call. The first audio signal can be voice data from a caller, such as caller 111D as show in FIG. 1B. Examples of a first audio signal include various types of inquiries and requests that caller 111D might make when they first connect with call processing system 130. For instance, caller 111D might say, “I need help understanding my latest bank statement,” indicating a general inquiry about account information. Another example could be caller 111D reporting, “I see a charge on my credit card that I didn't authorize,” which signals an urgent intent related to potential misuse. Caller 111D might also state, “I can't access my online banking account,” highlighting an issue with account access or technical support. Additionally, caller 111D might request, “I'd like to open a new savings account,” demonstrating a service request for account setup. Complaints can also serve as a first audio signal, such as caller 111D saying, “I was overcharged on my last bill, and I need this corrected.” Other examples include general inquiries like, “What are your business hours?” or transaction-related questions such as, “Can you tell me if my recent payment has been processed?” Each of these examples helps the call processing system identify the caller's intent and determine the appropriate response and prioritization for handling the call effectively, based on the content of the call.

At operation 210, the processor analyzes the intent of the call using operational instructions stored in memory. These operational instructions include a large language model (LLM) that is trained to recognize various intents from a predefined set. This set can cover a wide range of scenarios, such as balance inquiries, reporting unauthorized transactions, resetting passwords, opening new accounts, requesting loan information, disputing charges, asking about interest rates, scheduling an appointment for a service, or seeking help with a mobile application. The predefined set of intents is tailored to the specific services being provided. For example, in some contexts, this set might include checking the status of a delivery, reporting a defective product, requesting technical support for a device, scheduling maintenance for a home appliance, inquiring about service availability in a particular area, upgrading a subscription plan, or registering for a demo.

At operation 212, method 200 includes determining a priority level for the call based on the identified intent, the caller's identity, and established prioritization rules, as previously discussed. These rules are stored in memory and provide a mapping that associates different combinations of call intents and user identities with corresponding priority levels. For instance, a call concerning suspected misuse might be assigned a higher priority than a general inquiry. Similarly, calls from high-value clients, such as those with large account balances or premium memberships, might also be prioritized higher to ensure swift and dedicated assistance. The priority level helps the system decide how quickly the call needs to be handled and which resources should be allocated.

It should be noted that intent and identity of the caller are only some of the factors that can determine the priority of the call, and as previously discussed various other factors such as metadata and contextual information can be used for determining the priority of the call.

At operation 214, method 200 includes determining that an optimal communication channel for the call is a virtual audio channel. The virtual audio channel can be determined based on the determined priority level and predefined channel selection criteria. For example, if the intent is checking an account balance, call processing system 130 can determine that the optimal communication channel for the call is the virtual audio channel. This decision is made to optimize the call handling process and reduce wait times by directing the call through a channel that best matches the caller's needs and the system's current capacity. The virtual audio channel is particularly effective for managing routine inquiries or requests that can be handled without direct human intervention. The communication via the virtual audio channel includes, at operation 216, receiving a second audio signal from the caller.

At operation 216, call processing system 130 can receive a second audio signal from the incoming call, which may represent a follow-up question or additional information provided by the caller in response to the initial prompts. The receipt of this second signal indicates that the call interaction is ongoing and requires further processing. In various cases, the audio stream from the caller (such as caller 111D) can be segmented into intervals, creating distinct audio signals (e.g., the first audio signal, the second audio signal, and so on) for different stages of the interaction. Such segmentation into intervals can be performed, for example, by communication module 141 upon receiving the audio stream. This segmentation can be done using various methods, such as dividing the audio stream into small segments of a specific duration, like one second, a few seconds, or half a second, and then assembling these segments into intervals that correspond to different requests. Intervals can be defined by detecting pauses in the audio stream; an interval might end when a pause occurs and a new one begins when the caller resumes speaking.

In various embodiments, different types of pauses can be distinguished, such as those indicating the end of a complete sentence versus a brief pause within a sentence caused by the caller's thinking or hesitating. Other techniques might include detecting changes in tone, pitch, or volume, which could signal a shift in conversation topics or the completion of a thought or using natural language processing (NLP) to recognize semantic breaks or changes in the subject matter. By utilizing these methods, the system can effectively segment the audio stream to better understand and respond to caller 111D.

At operation 218, method 200 involves converting the second audio signal into a text transcript. This conversion allows for a more detailed analysis and processing of the caller's input using text-based methods. By transforming the audio into text, the system can use advanced LLMs to better understand the caller's requests. At operation 220, method 200 involves using the VA LLM, as previously discussed, to process the text transcript and generate a text output in response to the request from caller 111D identified in the transcript. The VA LLM is specifically trained to handle a wide range of customer inquiries and deliver relevant, accurate answers based on the content of the text transcript.

At operation 222, method 200 includes converting the text output into an audio output using text-to-voice operational instructions. The conversion can be achieved via text-to-voice operational instructions. This operation ensures that the response is provided via an audio call, thereby maintaining a seamless and natural interaction for the user.

At operation 224 method 200 includes transmitting the audio output to the user in response to the second audio signal. The audio output generated from the text is transmitted back to caller 111D in response to their second audio signal.

At operation 226, method 200 includes determining whether the call interaction has been resolved. A call interaction is considered resolved when it is nearing completion, with all of the caller's requests being addressed. During this phase of the call, the conversation may be summarized, the caller's requests confirmed as addressed, and any final instructions or information provided before ending the call.

The determination that the call interaction is resolved can be made by analyzing the text transcript data using the VA LLM to assess if all the caller's needs have been addressed. If the call is determined to be resolved (operation 226, Yes), method 200 concludes. However, if it is determined that the call is not resolved (operation 226, No), method 200 proceeds to operation 228. At operation 228, the method includes generating a prompt for the caller (e.g., caller 111D) and transmitting the corresponding audio output to the caller. Following this, method 200 returns to operation 216, where it receives another audio signal from the ongoing call.

In various embodiments, the call processing system 130 includes channel selection criteria that map different priority levels to a set of communication channels. These channel selection criteria consist of predefined rules or algorithms designed to determine the most appropriate communication channel, such as phone, chat, email, or virtual audio channels, based on the priority of the call. As described earlier, priority levels can be numerical values indicating the urgency or importance of a call, or they can be categorical indicators like “high,” “medium,” or “low.” The channel selection criteria can be organized in a table that associates specific communication channels with corresponding ranges of priority levels. For example, if a call's priority level falls within a certain range, call processing system 130 may select the virtual audio channel to handle the call.

In various embodiments, prioritization rules can map a user's emotional state to the priority level of a call. These rules serve as guidelines to assign priority levels based on various factors, including the caller's emotional state. The emotional state refers to the caller's feelings or emotions during the call, such as frustration, anger, calmness, or satisfaction, which can influence how urgently the call should be handled. The call processing system 130 can use a machine learning model (MLM) configured to analyze the first audio signal of the call and generate an output vector of values. This vector comprises a set of numerical values, each representing a different emotion from a predefined set (e.g., happy, sad, angry). For example, the large language model (LLM) used by the call processing system 130 or the virtual assistant LLM (VA LLM) employed by the chat agent queue manager 171, as shown in FIG. 1B, can include an emotional intelligence machine learning model (EI MLM). This model is trained to detect and interpret emotions from audio signals (and, in some cases, text transcripts), enabling the system to identify the caller's emotional state.

In one example embodiment, the call processing system 130 is configured to determine the emotional state of a caller in real time. The system first analyzes the emotional state conveyed in the initial audio signal and then evaluates a second emotional state based on a subsequent audio signal received later. This approach involves continuously monitoring call audio data to identify any changes in the caller's emotional state over time. Based on the detected emotional state, the change in emotional state, and the user's identity, the call processing system 130 can assess whether the priority level exceeds a specific emotional threshold or if the change in emotional state surpasses a predefined emotional change threshold. The emotional threshold is a predefined value that, when exceeded, suggests that the call should be escalated to a human-operated audio channel. Similarly, the emotional change threshold is a predefined value that, when exceeded, indicates that the call should be transferred to a human agent.

In various embodiments, call processing system 130 can be configured to store telemetry data for each user call interaction. Telemetry in this context refers to the automatic collection and transmission of data about the call, such as its length, the intent of the call (the purpose or reason behind the call, like making a payment or asking for information), and a temporal emotional state profile. The temporal emotional state profile tracks the changes in the user's emotional state over time during the call, showing how emotions evolve as the conversation progresses.

In some embodiments, call processing system 130 is configured to perform text-to-voice conversion using a selected voice profile. A voice profile refers to the specific characteristics or settings used to generate synthetic speech, tailored to match certain preferences or conditions, such as a soothing tone or an authoritative voice. The system selects the voice profile based on the user's temporal emotional state profiles, which are generated from the user's past interactions with various voice profiles. By selecting the most suitable voice profile, the system can enhance the user's emotional experience, improving their overall satisfaction and engagement.

Further, call processing system 130 is configured to select the language of the text output based on the user's language preferences as determined by their historical interactions. Language preferences refer to the user's preferred language for communication, which the system learns over time by analyzing past interactions. This ensures that the communication is always in the user's preferred language, making the interaction more comfortable and effective.

Additionally, in some cases, call processing system 130 can be configured to select a voice profile based on the intent identified in the first audio signal. By aligning the voice profile with the identified intent, the system enhances the relevance and appropriateness of the responses, making the interaction more natural and effective.

In various embodiments, the call processing system 130 can be further configured to classify the response as either successful or unsuccessful after identifying the emotional state of the caller. This classification helps determine whether the user's needs have been satisfactorily met. If the response is classified as unsuccessful-indicating user dissatisfaction or confusion—the system can present a clarifying question to steer the conversation towards a more favorable outcome, potentially extending the call to better address the user's needs. Additionally, or alternatively, the determination of whether the response is successful or unsuccessful can be made by analyzing the text transcript data.

As previously described, when communicating through the chat agent queue manager 171 channel, as shown in FIG. 1B, an audio signal is converted into a text transcript, which is then analyzed by the VA LLM. The VA LLM generates a text output in response to a request identified in the text transcript. This text output is subsequently converted back into an audio output and transmitted to the caller. In various scenarios, this process can be performed even for the initial audio signal received by the call processing system 130, before the system decides to transfer the call to the chat agent queue manager 171 channel. For instance, this process can be used to identify the intent of the call based on the analysis of the first audio signal.

In some embodiments, call processing system 130 can be further configured to monitor the ongoing interaction context and customer preferences in real-time based on an audio stream of the call. This real-time monitoring involves continuously analyzing the audio stream by converting segments of the audio into corresponding text transcripts. The system uses the VA LLM to process these text segments, determining if the current communication channel remains suitable or if it needs to be switched to a different one. This dynamic assessment ensures that the interaction stays aligned with the user's needs and preferences, maintaining the continuity of the conversation even if a channel switch is necessary.

In some embodiments, call processing system 130 can be is configured to confirm any proposed channel transition by communicating it to the user before executing the switch. This confirmation process ensures that the user is informed and consents to the change, preventing confusion and ensuring a smooth transition. It maintains user trust and satisfaction by keeping the user in control of the communication process.

### Implementation of Feedback to Optimize Channel Selection Performance

Feedback from historical data plays an important role in improving the effectiveness of call processing system 130, especially in refining channel selection and setting priorities for future interactions. The system leverages historical data to evaluate the success or failure of previous interactions with various callers. Such data includes various indicators, such as the overall context of the interaction, the user's emotional state, the length of the conversation, and the user's effort to navigate through different interfaces. For example, a successful interaction might be characterized by a calm emotional state, a concise conversation that resolves the issue efficiently, and/or minimal need for switching between communication channels. Conversely, an unsuccessful interaction may involve signs of user frustration, extended conversation times, multiple transfers between agents or channels, or a large number of previous calls regarding the same issue.

To analyze this data, call processing system 130 employs natural language processing (NLP) and sentiment analysis algorithms to extract contextual and emotional cues from both spoken and written text. Machine learning models, such as supervised learning algorithms, can be trained on labeled data indicating the success or failure of past interactions. These models can identify patterns associated with successful outcomes, such as specific phrases, tones, or conversation structures that correlate with high user satisfaction. Additionally, unsupervised learning techniques like clustering can uncover patterns in user behavior that are not immediately apparent, such as common pathways through multiple channels or sequences of actions that lead to a successful resolution.

Call processing system 130 can be configured to dynamically adjust its strategy for selecting communication channels and determining the priority of future interactions based on these insights. For instance, if a user demonstrates a pattern of successful outcomes when interacting with a specific channel or using a particular voice, the system can prioritize that channel or voice in future interactions. Similarly, if data reveals that a user often becomes frustrated when using a specific interface, the system can avoid that interface in subsequent communications. This approach ensures that each user's preferences and past experiences are considered, leading to a more efficient and satisfactory interaction.

To scale these adjustments across a large pool of users, call processing system 130 can employ a statistical approach that aggregates data from numerous users to identify common patterns and preferences. Decision trees can be used to classify different users into various groups based on shared characteristics, such as geographic location, customer value (e.g., high-value customers), or typical interaction patterns. Each group can then be analyzed to determine which channels have historically yielded the most effective outcomes. Different machine learning models can be trained for each user group to optimize channel selection. For example, high-value customers might be routed to channels with higher human involvement, while users in areas with poor connectivity might be directed to text-based channels less affected by network quality issues.

Additionally, the system can use embedding techniques to transform contextual information, such as user metadata and conversation content, into vector representations that machine learning models can process. These embeddings capture the nuances of user preferences and behavior, allowing the models to make more nuanced predictions. Reinforcement learning techniques could also be applied to continuously update and refine the models based on new data, enabling the system to adapt to evolving user behavior and preferences over time.

### Network and System Implementation

Various computer systems, devices, and networks can be utilized to implement call handling within an environment, such as the one depicted in FIGS. 1A and 1B.

Referring to FIG. 1A, network 120 and the various computing components of the call processing system 130 can be implemented using a wide range of hardware and software devices, systems, and resources. Network 120 may encompass different types of networks, such as portions of an intranet, peer-to-peer networks, switched telephone networks, local area networks (LANs), wide area networks (WANs), metropolitan area networks (MANs), personal area networks (PANs), wireless personal area networks (WPANs), overlay networks, software-defined networks (SDNs), virtual private networks (VPNs), mobile telephone networks (e.g., 4G or 5G cellular networks), plain old telephone service (POTS) networks, wireless data networks (e.g., WiFi, WiGig, WiMax), long-term evolution (LTE) networks, universal mobile telecommunications system (UMTS) networks, Bluetooth networks, near-field communication (NFC) networks, and other suitable network types. Network 120 can be configured to support various communication protocols, as would be appreciated by those skilled in the art.

The call processing system 130 can be implemented using a diverse range of hardware and software components. For instance, the system includes various modules that may be executed on different computing devices, systems, and operational instructions stored in memory devices.

Call processing system 130 includes one or more memory devices for electronically digitally storing data and instructions to be executed by any of processors of call processing system 130. The memory may include volatile memory such as various forms of random-access memory (RAM) or other dynamic storage device. The memory also may be used for storing temporary variables or other intermediate information during the execution of instructions to be executed by various processors of call processing system 130. Such instructions, when stored in non-transitory computer-readable storage media accessible to various processors of call processing system 130, can render call processing system 130 into a special-purpose machine customized to perform the operations specified in the instructions.

In some cases, call processing system 130 includes non-volatile memory such as read-only memory (ROM) or other static storage devices for storing information and instructions for various processors of call processing system 130. The ROM may include various forms of programmable ROM (PROM), such as erasable PROM (EPROM) or electrically erasable PROM (EEPROM). The memory may have any number of units of persistent storage, which may include various forms of non-volatile RAM (NVRAM), such as FLASH memory, solid-state storage, magnetic disk, or optical disks such as CD-ROM or DVD-ROM and may be coupled to a suitable I/O subsystem for storing information and instructions.

The instructions in the memory may comprise one or more instructions organized as modules, methods, objects, functions, routines, or calls. The instructions may be organized as one or more computer programs, operating system services, or application programs, including mobile apps. The instructions may comprise an operating system and/or system software; one or more libraries to support multimedia, programming, or other functions; data protocol instructions or stacks to implement TCP/IP, HTTP, or other communication protocols; file format processing instructions to parse or render files coded using HTML, XML, JPEG, MPEG or PNG; user interface instructions to render or interpret commands for a graphical user interface (GUI), command-line interface or text user interface; application software such as an office suite, internet access applications, design and manufacturing applications, graphics applications, audio applications, software engineering applications, educational applications or miscellaneous applications. The instructions may implement a web server, web application server, or web client. The instructions may be organized as a presentation, application, and data storage layer, such as a relational database system using a structured query language (SQL) or no SQL, an object store, a graph database, a flat file system, or other data storage.

The processors used by the computing devices of call processing system 130 can include a variety of processing units, such as central processing units (CPUs), graphics processing units (GPUs), digital signal processors (DSPs), and application-specific integrated circuits (ASICs). These processors are designed to execute instructions stored in memory to perform various computational tasks required by the call processing system 130. This encompasses running algorithms for machine learning models (MLMs), large language models (LLMs), virtual assistant language models (VA LLMs), text-to-speech conversion, audio-to-text transcription, sentiment analysis, and other advanced processing techniques.

The memory devices within the various computing devices of call processing system 130 are configured to store these instructions, which implement different algorithms and methods to effectively handle call processing tasks. For example, the stored instructions might include those needed for deploying large language models (LLMs) that generate natural language responses, machine learning models (MLMs) that predict caller intent and prioritize interactions, virtual assistant models that manage voice-activated queries, text-to-speech modules that convert written text into spoken words, and audio-to-text modules that transcribe spoken language into text. This setup ensures that the call processing system is capable of delivering a sophisticated and responsive user experience by dynamically adapting to different types of calls and user requirements.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated with another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

1. A system for reducing a call wait time, the system comprising:
a memory configured to store user profile data, prioritization rules, channel selection criteria, and operational instructions; and
a processor operably coupled to the memory, the processor configured to:
analyze a first audio signal of a call to identify an intent of the call selected from a set of intents using the operational instructions, the operational instructions comprising a large language model (LLM) trained to identify the intent;
determine a priority level for the call based on the identified intent, an identity of a user, and the prioritization rules, the prioritization rules comprising an established mapping that associates a combination of the set of intents and the identity of the user with a corresponding priority level for the call; and
based on the determined priority level and the channel selection criteria, determine that an optimal communication channel for the call is a virtual audio channel, wherein communicating via the virtual audio channel comprises the processor to:
receive a second audio signal of the call;
convert the second audio signal into a text transcript;
use the operational instructions comprising a virtual assistant (VA) LLM to process the text transcript and generate a text output;
convert the text output into an audio output using text-to-voice operational instructions; and
transmit the audio output to the user in response to the second audio signal.

2. The system of claim 1, wherein the channel selection criteria provide a mapping between priority level values and a set of communication channels, and wherein the optimal communication channel for the call is determined to be the virtual audio channel when the priority level of the call is within a specified range of priority level values.

3. The system of claim 1, wherein the prioritization rules further include a mapping between an emotional state of the user and the priority level, and wherein the emotional state of the user is determined by the processor configured to receive the first audio signal and generate an output vector of values using the operational instructions comprising emotional intelligence machine learning model (EI MLM), each value from the output vector of values corresponding to a particular type of emotion from a set of emotions.

4. The system of claim 3, wherein the processor is further configured to:
determine the emotional state of the user based on the second audio signal; and
based on the emotional state and the identity of the user, determine that priority level value is above a priority level threshold after which a switch to a human-operated audio channel is suggested.

5. The system of claim 3, wherein the processor is further configured to:
store call interaction telemetry for each user, the call interaction telemetry including a length of the call, the intent of the call, a temporal emotional state profile during the call, wherein the temporal emotional state profile corresponds to a time evolution of the emotional state during the call.

6. The system of claim 5, wherein the processor is configured to perform text-to-voice conversion using a selected voice profile, wherein the selected voice profile is determined based on temporal emotional state profiles of the user during previous interactions with different voice profiles.

7. The system of claim 1, wherein the processor is further configured to:
monitor ongoing interaction context and customer preferences in real-time based on an audio stream of the call, wherein monitoring comprises the processor to:
convert segments of the audio stream into segment associated text transcript;
process the segment associated text transcript to determine that a current communication channel needs to be switched to a new communication channel using the operational instructions comprising the VA LLM; and
transition the user to the new communication channel while maintaining a continuity of a conversation.

8. A method for reducing a call wait time, the method comprising:
analyzing a first audio signal of a call to identify an intent of the call selected from a set of intents using a large language model (LLM) trained to identify the intent;
determining a priority level for the call based on the identified intent, an identity of a user, and prioritization rules, the prioritization rules comprising an established mapping that associates a combination of the set of intents and the identity of the user with a corresponding priority level for the call; and
based on the determined priority level and channel selection criteria, determining that an optimal communication channel for the call is a virtual audio channel, wherein communicating via the virtual audio channel comprises:
receiving a second audio signal of the call;
converting the second audio signal into a text transcript;
using a virtual assistant (VA) LLM processing the text transcript and generating a text output;
converting the text output into an audio output using text-to-voice operational instructions; and
transmitting the audio output to the user in response to the second audio signal.

9. The method of claim 8, further comprising determining whether the call has been resolved, wherein the determining is performed using the VA LLM based on the text transcript, and when the call has not been resolved providing the audio output to the user containing a prompt requesting more information from the user.

10. The method of claim 8, wherein the channel selection criteria provide a mapping between priority level values and a set of communication channels, and wherein the optimal communication channel for the call is determined to be the virtual audio channel when the priority level of the call is within a specified range of priority level values.

11. The method of claim 8, wherein the prioritization rules further include a mapping between an emotional state of the user and the priority level, and wherein the emotional state of the user is determined by receiving the first audio signal and generating an output vector of values using an emotional intelligence machine learning model (EI MLM), each value from the output vector of values corresponding to a particular type of emotion from a set of emotions.

12. The method of claim 11, further comprising:
determining the emotional state of the user based on the second audio signal; and
based on the emotional state and the identity of the user, determining that priority level value is above a priority level threshold after which a switch to a human-operated audio channel is suggested.

13. The method of claim 11, further comprising storing call interaction telemetry for each user, the call interaction telemetry including a length of the call, the intent of the call, a temporal emotional state profile during the call, wherein the temporal emotional state profile corresponds to a time evolution of the emotional state during the call.

14. The method of claim 13, further comprising performing text-to-voice conversion using a selected voice profile, wherein the selected voice profile is determined based on temporal emotional state profiles of the user during previous interactions with different voice profiles.

15. The method of claim 8, further comprising:
monitoring ongoing interaction context and customer preferences in real-time based on an audio stream of the call, wherein monitoring includes:
converting segments of the audio stream into segment associated text transcript;
processing the segment associated text transcript to determine that a current communication channel needs to be switched to a new communication channel using the VA LLM; and
transitioning the user to the new communication channel while maintaining a continuity of a conversation.

16. A non-transitory computer-readable medium storing instructions that, when executed by one or more processors, cause the one or more processors to:
analyze a first audio signal of a call to identify an intent of the call selected from a set of intents using the instructions, the instructions comprising a large language model (LLM) trained to identify the intent;
determine a priority level for the call based on the identified intent, an identity of a user, and prioritization rules, the prioritization rules comprising an established mapping that associates a combination of the set of intents and the identity of the user with a corresponding priority level for the call; and
based on the determined priority level and channel selection criteria, determine that an optimal communication channel for the call is a virtual audio channel, wherein communicating via the virtual audio channel involves the one or more processors to:
receive a second audio signal of the call;
convert the second audio signal into a text transcript;
use the instructions comprising a virtual assistant (VA) LLM to process the text transcript and generate a text output;
convert the text output into an audio output using text-to-voice operational instructions; and
transmit the audio output to the user in response to the second audio signal.

17. The non-transitory computer-readable medium of claim 16, wherein the channel selection criteria provide a mapping between priority level values and a set of communication channels, and wherein the optimal communication channel for the call is determined to be the virtual audio channel when the priority level of the call is within a specified range of priority level values.

18. The non-transitory computer-readable medium of claim 16, wherein the prioritization rules further include a mapping between an emotional state of the user and the priority level, and wherein the emotional state of the user is determined by the one or more processors configured to receive the first audio signal and generate an output vector of values using the instructions comprising emotional intelligence machine learning model (EI MLM), each value from the output vector of values corresponding to a particular type of emotion from a set of emotions.

19. The non-transitory computer-readable medium of claim 18 storing the instructions that, when executed by the one or more processors, cause the one or more processors to:
determining the emotional state of the user based on the second audio signal; and
based on the emotional state and the identity of the user, determining that priority level value is above a priority level threshold after which a switch to a human-operated audio channel is suggested.

20. The non-transitory computer-readable medium of claim 18, storing the instructions that, when executed by the one or more processors, cause the one or more processors to store call interaction telemetry for each user, the call interaction telemetry including a length of the call, the intent of the call, a temporal emotional state profile during the call, wherein the temporal emotional state profile corresponds to a time evolution of the emotional state during the call.
